(19) United States
(12) Patent Application Publication
(10) Pub. No.: US 2024/0346649 A1
(43) Pub. Date: Oct. 17, 2024

(54) VESSEL PATH IDENTIFICATION FROM EXTRAVASCULAR IMAGE OR IMAGES

(71) Applicant: Boston Scientific Scimed Inc., Maple Grove, MN (US)

(72) Inventor: Erik Stephen Freed, Maple Grove, MN (US)

(73) Assignee: Boston Scientific Scimed Inc., Maple Grove, MN (US)

(21) Appl. No.: 18/637,087

(22) Filed: Apr. 16, 2024

Related U.S. Application Data
(60) Provisional application No. 63/459,865, filed on Apr. 17, 2023.

(51) Int. Cl. G06T 7/00; G06T 5/20; G06T 5/70; G06T 5/90

(52) U.S. Cl. CPC G06T 7/0012; G06T 5/20; G06T 5/70; G06T 5/90; G06T 2207/10121; G06T 2207/20048; G06T 2207/30101

(57) ABSTRACT

The disclosure provides methods and systems for medical imaging devices to route a path of a vessel on an extravascular image based on at least two points indicated on the image. An image speed map can be generated from the extravascular image and a list of the shortest path from points on the image to a selected point on the image can be identified from the image speed map. Then the path from another point on the image to the selected point on the image identified based on the identified shortest paths.

### CROSS-REFERENCE TO RELATED APPLICATIONS

This application claims the benefit of U.S. Provisional Patent Application Ser. No. 63/459,865 filed on Apr. 17, 2023, the disclosure of which is incorporated herein by reference.

### TECHNICAL FIELD

The present disclosure pertains to medical imaging. More particularly, the present disclosure pertains to identifying a path of a vessel in a medical image.

### BACKGROUND

Medical imaging is used to treat and diagnose vascular diseases. There are a large number of imaging modalities that are used to generate medical images, including video, fluoroscopy, angiography, ultrasound, CT, MR, PET, PET-CT, CT angiography, SPECT, Gamma camera imaging, Optical Coherence Tomography (OCT), Near-Infra-Red Spectroscopy (NIRS), Vibration Response Imaging (VRI), optical imaging, infrared imaging, electrical mapping imaging, other forms of functional imaging, Focused Acoustic Computed Tomography (FACT), Optical Frequency Domain Imaging (OFDI).

Additionally, there are a large variety of endoluminal medical devices that are used both for therapeutic and diagnostic purposes. Devices such as intravascular ultrasound (IVUS) probes, fractional flow reserve (FFR), and instantaneous wave-free ratio (iFR) probes typically acquire endoluminal data while moving through a lumen.

Often, it is desirable to identify the physiological characteristics of the vessel to be treated. For example, the centerline of a vessel that has been imaged externally can be determined either to render a roadmap of the vessel and/or to co-register the external image with endoluminal images (e.g., IVUS images, or the like).

### BRIEF SUMMARY

In general, the present disclosure provides for identifying the path of a vessel between at least two points in an extravascular image. The present disclosure can be used in pre-percutaneous coronary interventions (PCI) and/or post-PCI procedures to define the shape of a vessel and/or co-register the extravascular image to intravascular images.

The present disclosure provides several advantages over prior or conventional techniques to identify a path of a vessel. For example, the present disclosure provides that significantly fewer points are required to be provided (e.g., by a physician, or the like) to adequately follow or identify the path of a vessel in an extravascular image. Further the present disclosure provides that the user (e.g., physician, or the like) can easily adjust the identified path (or shape) of the vessel and receive real-time feedback of the adjusted or modified path.

In some embodiments, the disclosure can be implemented as a computer-implemented method. The computer-implemented method can comprise receiving, at processing circuitry, an extravascular image from an extravascular imaging device, the extravascular image comprising indications of a vessel; generating, by the processing circuitry, an image speed map based on the extravascular image; receiving, by the processing circuitry, an indication of a first point on the extravascular image, the first point corresponding to a portion of the vessel; identifying, by the processing circuitry, a shortest distance from each of a plurality of pixels on the image to the first point based on the image speed map; receiving, by the processing circuitry, an indication of a second point on the extravascular image, the second point correspond to another portion of the vessel; and determining, by the processing circuitry, a path of the vessel based on the second point and the shortest distance from each of the plurality of pixels to the first point.

In further embodiments, the method can comprise smoothing the path.

In further embodiments of the method, the path comprises a midpoint and smoothing the path comprises adding an intermediate point along the path on either side of the midpoint; identifying a shortest path from each of the intermediate midpoints to respective ones of the first point and the second point; selecting a line or curve segment from a plurality of line or curve segments connecting the intermediate points based in part on the shortest path from each of the intermediate midpoints to respective ones of the first point and the second point; and forming a path from the shortest path the selected line or curve segment and the shortest path from each of the intermediate midpoints to respective ones of the first point and the second point.

In further embodiments, the method can comprise generating, by the processing circuitry, the image speed map comprising de-speckling the extravascular image to generate a de-speckled extravascular image; normalizing the brightness and/or contrast of the de-speckled extravascular image to generate a normalized extravascular image; and darkening a centerline of the vessel based in part on the de-speckled extravascular image to generate the image speed map.

In further embodiments, the method can comprise generating, by the processing circuitry, the image speed map further comprising identifying ambient light in the de-speckled extravascular image; and removing the ambient light from the de-speckled extravascular image to form a light adjusted extravascular image, wherein the normalized extravascular image is generate based on the light adjusted extravascular image.

In further embodiments, the method can comprise identifying ambient light in the de-speckled image based on a blurring filter having a median diameter between 30 and 120 pixels.

In further embodiments, the method can comprise applying a Gaussian kernel to the extravascular image to de-speckle the extravascular image.

In further embodiments of the method, the Gaussian kernel is a 3 pixel by 3 pixel diameter Gaussian kernel.

In further embodiments, the method can comprise iteratively applying a mask to portions of the normalized image to progressively darken pixels corresponding to portions of the vessel represented on the normalized image based on a distance of the pixel from the vessel border.

In further embodiments, the method can comprise applying a gradient transformation to the centerline darkened image to generate the vessel speed map.

In further embodiments of the method, the gradient transformation is a Sigmoid transformation or a linear transformation.

In further embodiments, the method can comprise identifying, by the processing circuitry, a shortest distance from each of a plurality of pixels on the image to the second point based on the image speed map; receiving an indication to move a location of the first point; and identifying an updated path of the vessel based on the moved first point and the shortest distance from each of the plurality of pixels to the second point.

In further embodiments, the method can comprise identifying, by the processing circuitry, a shortest distance from each of a plurality of pixels on the image to the second point based on the image speed map; receiving an indication of a midpoint on the extravascular image; and identifying an updated path of the vessel based on the midpoint and the shortest distance from each of the plurality of pixels to the first point and the midpoint and the shortest distance from each of the plurality of pixels to the second point.

In some embodiments, the disclosure can be implemented as a computing device to be coupled to an extravascular imaging machine (e.g., an angiogram machine). The computing device can comprise a processor and memory coupled to the processor, the memory comprising instructions that when executed by the processor cause the computing device to perform any of the methods described herein.

In some embodiments, the disclosure can be implemented as a computer-readable medium comprising instructions, which when executed by a processor of a medical imaging device cause the medical imaging device to perform any of the methods described herein.

With some embodiments, the disclosure can be implemented as a computing device for an extravascular image processing system. The computing device can comprise a processor; and a memory device coupled to the processor, the memory device comprising instructions that when executed by the processor cause the computing device to receive an extravascular image from an extravascular imaging device, the extravascular image comprising indications of a vessel; generate, by the processing circuitry, an image speed map based on the extravascular image; receive, by the processing circuitry, an indication of a first point on the extravascular image, the first point corresponding to a portion of the vessel; identify, by the processing circuitry, a shortest distance from each of a plurality of pixels on the image to the first point based on the image speed map; receive, by the processing circuitry, an indication of a second point on the extravascular image, the second point correspond to another portion of the vessel; and determine, by the processing circuitry, a path of the vessel based on the second point and the shortest distance from each of the plurality of pixels to the first point.

In further embodiments of the computing device, the path comprises a midpoint and the instructions, which when executed by the processor, further cause the computing device to add an intermediate point along the path on either side of the midpoint; identify a shortest path from each of the intermediate midpoints to respective ones of the first point and the second point; select a line or curve segment from a plurality of line or curve segments connecting the intermediate points based in part on the shortest path from each of the intermediate midpoints to respective ones of the first point and the second point; and form a path from the shortest path the selected line or curve segment and the shortest path from each of the intermediate midpoints to respective ones of the first point and the second point.

In further embodiments of the computing device, the instructions, which when executed by the processor, further cause the computing device to de-speckle the extravascular image to generate a de-speckled extravascular image; identifying ambient light in the de-speckled extravascular image; removing the ambient light from the de-speckled extravascular image to form a light adjusted extravascular image; normalize the brightness and/or contrast of the light adjusted extravascular image; darken a centerline of the vessel based in part on the de-speckled extravascular image to form a centerline darkened image; and apply a gradient transformation to the centerline darkened image to generate the image speed map.

In further embodiments of the computing device, the instructions, which when executed by the processor, further cause the computing device to identifying ambient light in the de-speckled image based on a blurring filter having a median diameter between 30 and 120 pixels.

With some embodiments, the disclosure can be implemented as a computer-readable medium for an extravascular image processing system. The computer-readable medium can comprise instructions, which when executed by a processor of the extravascular image processing system cause the extravascular image processing system to receive an extravascular image from an extravascular imaging device, the extravascular image comprising indications of a vessel; generate, by the processing circuitry, an image speed map based on the extravascular image; receive, by the processing circuitry, an indication of a first point on the extravascular image, the first point corresponding to a portion of the vessel; identify, by the processing circuitry, a shortest distance from each of a plurality of pixels on the image to the first point based on the image speed map; receive, by the processing circuitry, an indication of a second point on the extravascular image, the second point correspond to another portion of the vessel; and determine, by the processing circuitry, a path of the vessel based on the second point and the shortest distance from each of the plurality of pixels to the first point.

In further embodiments of the computer-readable medium the instructions, which when executed by the processor of the extravascular image processing system cause the extravascular image processing system to add an intermediate point along the path on either side of the midpoint; identify a shortest path from each of the intermediate midpoints to respective ones of the first point and the second point; select a line or curve segment from a plurality of line or curve segments connecting the intermediate points based in part on the shortest path from each of the intermediate midpoints to respective ones of the first point and the second point; and form a path from the shortest path the selected line or curve segment and the shortest path from each of the intermediate midpoints to respective ones of the first point and the second point.

In further embodiments of the computer-readable medium the instructions, which when executed by the processor of the extravascular image processing system cause the extravascular image processing system to de-speckle the extravascular image to generate a de-speckled extravascular image; identifying ambient light in the de-speckled extravascular image; removing the ambient light from the de-speckled extravascular image to form a light adjusted extravascular image; normalize the brightness and/or contrast of the light adjusted extravascular image; darken a centerline of the vessel based in part on the de-speckled extravascular image to form a centerline darkened image; and apply a gradient transformation to the centerline darkened image to generate the image speed map.

### BRIEF DESCRIPTION OF THE SEVERAL VIEWS OF THE DRAWINGS

To easily identify the discussion of any element or act, the most significant digit or digits in a reference number refer to the figure number in which that element is first introduced.

FIG. 1 illustrates a vessel imaging system in accordance with at least one embodiment of the disclosure.

FIG. 2 illustrates vessel path identification system, in accordance with at least one embodiment of the disclosure.

FIG. 3 illustrates a method to identify a vessel path in accordance with at least one embodiment of the disclosure.

FIG. 4A, FIG. 4B, FIG. 4C, and FIG. 4D illustrates a path routed on an extravascular image of a vessel in accordance with at least one embodiment of the disclosure.

FIG. 5 illustrates a method to identify a vessel path in accordance with at least one embodiment of the disclosure.

FIG. 6 graphically illustrates a method to identity a vessel path in accordance with at least one embodiment of the disclosure.

FIG. 7 illustrates a method to identity a vessel path in accordance with at least one embodiment of the disclosure.

FIG. 8 illustrates a method to identity a vessel path in accordance with at least one embodiment of the disclosure.

FIG. 9 graphically illustrates a method to identity a vessel path in accordance with at least one embodiment of the disclosure.

FIG. 10 illustrates a method to identity a vessel path in accordance with at least one embodiment of the disclosure.

FIG. 11 graphically illustrates a method to identity a vessel path in accordance with at least one embodiment of the disclosure.

FIG. 12 illustrates a computer-readable storage medium.

FIG. 13 illustrates a diagrammatic representation of a machine.

### DETAILED DESCRIPTION

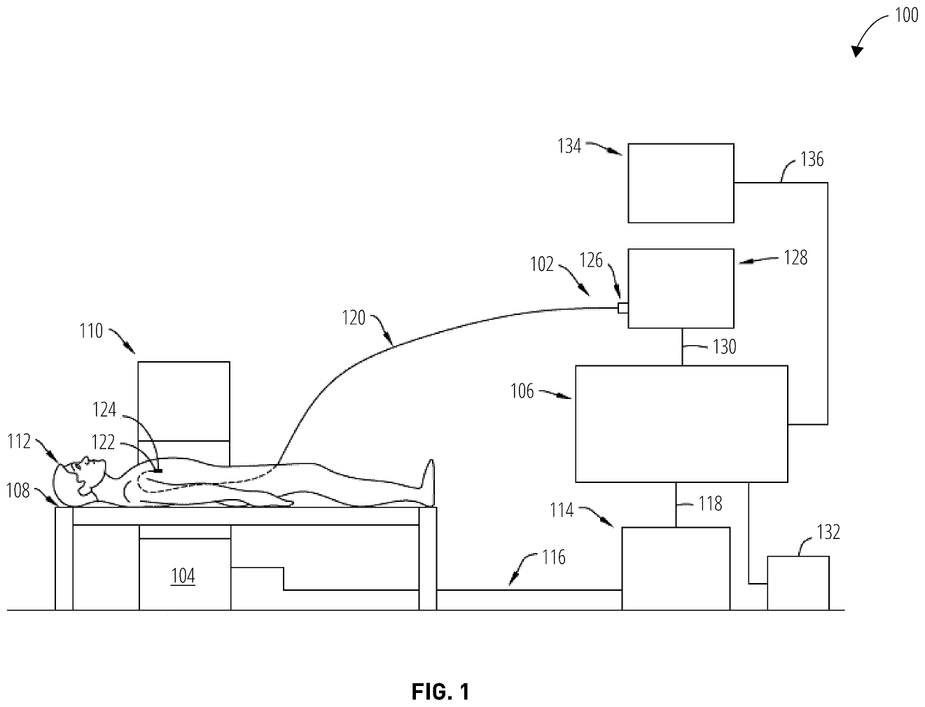

As noted, the present disclosure provides systems and techniques to identify a vessel pathway on an extravascular image of a vessel. As such, an illustrative vessel imaging device is described. FIG. 1 illustrates a combined internal and external imaging system 100 including both an endoluminal imaging system 102 (e.g., an IVUS imaging system, or the like) and an extravascular imaging system 104 (e.g., an angiographic imaging system). Combined internal and external imaging system 100 further includes computing device 106, which includes circuitry, controllers, and/or processor(s) and memory and software configured to execute a method for vascular imaging and identification of a vascular path as described herein. It is to be appreciated that the systems and methods described herein do not need endoluminal imaging, that a combined imaging system is described for clarity of presentation. For example, the image identification techniques described herein to identify a route or path of the vessel on an extravascular image can be used to co-register the extravascular image with a series of intravascular or endoluminal images. In general, the endoluminal imaging system 102 can be arranged to generate intravascular imaging data (e.g., IVUS images, or the like) while the extravascular imaging system 104 can be arranged to generate extravascular imaging data (e.g., angiogram images, or the like).

The extravascular imaging system 104 may include a table 108 that may be arranged to provide sufficient space for the positioning of an angiography/fluoroscopy unit c-arm 110 in an operative position in relation to a patient 112 on the drive unit. C-arm 110 can be configured to acquires fluoroscopic images in the absence of contrast agent in the blood vessels of the patient 112 and/or acquire angiographic image while there is a presence of contrast agent in the blood vessels of the patient 112.

Raw radiological image data acquired by the c-arm 110 may be passed to an extravascular data input port 114 via a transmission cable 116. The input port 114 may be a separate component or may be integrated into or be part of the computing device 106. The input port 114 may include a processor that converts the raw radiological image data received thereby into extravascular image data (e.g., angiographic/fluoroscopic image data), for example, in the form of live video, DICOM, or a series of individual images. The extravascular image data may be initially stored in memory within the input port 114 or may be stored within memory of computing device 106. If the input port 114 is a separate component from the computing device 106, the extravascular image data may be transferred to the computing device 106 through the transmission cable 116 and into an input port (not shown) of the computing device 106. In some alternatives, the communications between the devices or processors may be carried out via wireless communication, rather than by cables as depicted.

The intravascular imaging data may be, for example, IVUS data or OCT data obtained by the endoluminal imaging system 102. The endoluminal imaging system 102 may include an intravascular imaging device such as an imaging catheter 120. The imaging catheter 120 is configured to be inserted within the patient 112 so that its distal end, including a diagnostic assembly or probe 122 (e.g., an IVUS probe), is in the vicinity of a desired imaging location of a blood vessel. A radiopaque material or marker 124 located on or near the probe 122 may provide indicia of a current location of the probe 122 in a radiological image. In some embodiments, imaging catheter 120 and/or probe 122 can include a guide catheter (not shown) that has been inserted into a lumen of the subject (e.g., a blood vessel, such as a coronary artery) over a guidewire (also not shown). However, in some embodiments, the imaging catheter 120 and/or probe 122 can be inserted into the vessel of the patient 112 without a guidewire.

With some embodiments, imaging catheter 120 and/or probe 122 can include both imaging capabilities as well as other data-acquisition capabilities. For example, FFR and/or iFR data, data related to pressure, flow, temperature, electrical activity, oxygenation, biochemical composition, or any combination thereof. In some embodiments, imaging catheter 120 and/or probe 122 can further include a therapeutic device, such as a stent, a balloon (e.g., an angioplasty balloon), a graft, a filter, a valve, and/or a different type of therapeutic endoluminal device.

Imaging catheter 120 is coupled to a proximal connector 126 to couple imaging catheter 120 to image acquisition device 128. Image acquisition device 128 may be coupled to computing device 106 via transmission cable 116, or a wireless connection. The intravascular image data may be initially stored in memory within the image acquisition device 128 or may be stored within memory of computing device 106. If the image acquisition device 128 is a separate component from computing device 106, the intravascular image data may be transferred to the computing device 106, via, for example, transmission cable 116.

The computing device 106 can also include one or more additional output ports for transferring data to other devices. For example, the computer can include an output port to transfer data to a data archive or memory device 132. The computing device 106 can also include a user interface (described in greater detail below) that includes a combination of circuitry, processing components and instructions executable by the processing components and/or circuitry to enable the image identification and vessel routing or pathfinding described herein and/or dynamic co-registration of intravascular and extravascular images using the identified vessel pathway.

In some embodiments, computing device 106 can include user interface devices, such as, a keyboard, a mouse, a joystick, a touchscreen device (such as a smartphone or a tablet computer), a touchpad, a trackball, a voice-command interface, and/or other types of user interfaces that are known in the art.

The user interface can be rendered and displayed on display 134 coupled to computing device 106 via display cable 136. Although the display 134 is depicted as separate from computing device 106, in some examples the display 134 can be part of computing device 106. Alternatively, the display 134 can be remote and wireless from computing device 106. As another example, the display 134 can be part of another computing device different from computing device 106, such as, a tablet computer, which can be coupled to computing device 106 via a wired or wireless connection. For some applications, the display 134 includes a head-up display and/or a head-mounted display. For some applications, the computing device 106 generates an output on a different type of visual, text, graphics, tactile, audio, and/or video output device, e.g., speakers, headphones, a smartphone, or a tablet computer. For some applications, the user interface rendered on display 134 acts as both an input device and an output device.

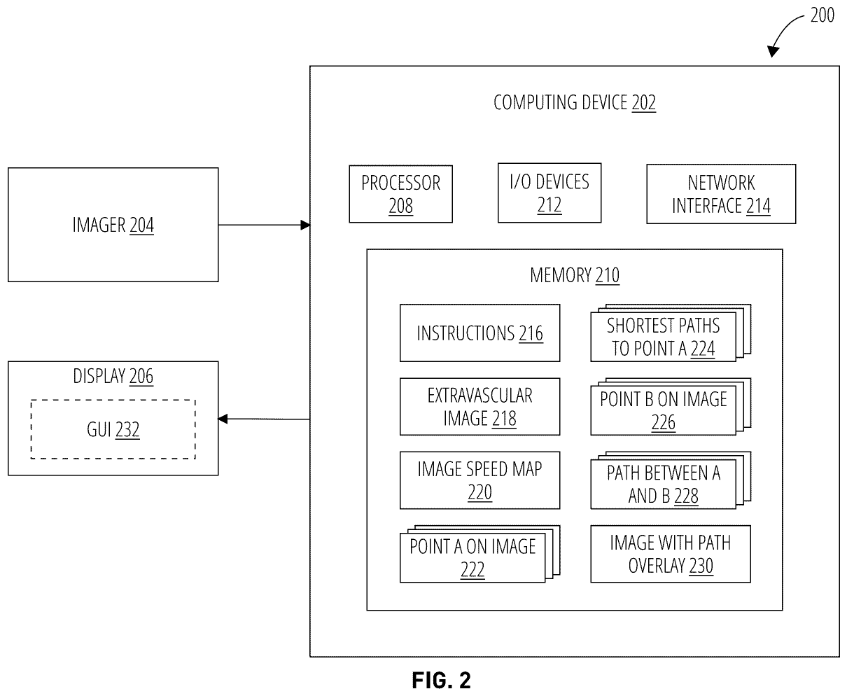

FIG. 2 illustrates a vessel path identification system 200, in accordance with non-limiting example(s) of the present disclosure. In general, vessel path identification system 200 is a system for identifying a path or route of a vessel from an extravascular image (e.g., an angiogram, or the like). In some embodiments, vessel path identification system 200 can be implemented as part of combined internal and external imaging system 100 of FIG. 1. For example, vessel path identification system 200 includes a computing device 202, which can be computing device 106 of FIG. 1. In vessel path identification system 200, computing device 202 is coupled to an imager 204 (e.g., c-arm 110, or the like). Likewise, computing device 202 is coupled to display 206 (e.g., display 134, or the like).

In general, imager 204 can generate information elements, or data, including indications of extravascular image 218. Computing device 202 is communicatively coupled to imager 204 and can receive the data including the indications of extravascular image 218 from imager 204. In general, extravascular image 218 can include pixels indicating a contrast and color of the extravascular image. This is described in greater detail below.

Computing device 202 can be any of a variety of computing devices. In some embodiments, computing device 202 can be incorporated into and/or implemented by a console of display 206. With some embodiments, computing device 202 can be a workstation or server communicatively coupled to imager 204 and/or display 206. With still other embodiments, computing device 202 can be provided by a cloud-based computing device, such as, by a computing as a service system accessibly over a network (e.g., the Internet, an intranet, a wide area network, or the like). Computing device 202 can include processor 208, memory 210, input and/or output (I/O) devices 212, and network interface 214.

The processor 208 may include circuity or processor logic, such as, for example, any of a variety of commercial processors. In some examples, processor 208 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 208 may include graphics processing portions and may include dedicated memory, multiple-threaded processing and/or some other parallel processing capability. In some examples, the processor 208 may be an application specific integrated circuit (ASIC) or a field programmable integrated circuit (FPGA).

The memory 210 may include logic, a portion of which includes arrays of integrated circuits, forming non-volatile memory to persistently store data or a combination of non-volatile memory and volatile memory. It is to be appreciated, that the memory 210 may be based on any of a variety of technologies. In particular, the arrays of integrated circuits included in memory 120 may be arranged to form one or more types of memory, such as, for example, dynamic random access memory (DRAM), NAND memory, NOR memory, or the like.

I/O devices 212 can be any of a variety of devices to receive input and/or provide output. For example, I/O devices 212 can include, a keyboard, a mouse, a joystick, a foot pedal, a display, a touch enabled display, a haptic feedback device, an LED, or the like.

Network interface 214 can include logic and/or features to support a communication interface. For example, network interface 214 may include one or more interfaces that operate according to various communication protocols or standards to communicate over direct or network communication links. Direct communications may occur via use of communication protocols or standards described in one or more industry standards (including progenies and variants). For example, network interface 214 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like. Additionally, network interface 214 can include logic and/or features to enable communication over a variety of wired or wireless network standards (e.g., 802.11 communication standards). For example, network interface 214 may be arranged to support wired communication protocols or standards, such as, Ethernet, or the like. As another example, network interface 214 may be arranged to support wireless communication protocols or standards, such as, for example, Wi-Fi, Bluetooth, ZigBee, LTE, 5G, or the like.

Memory 210 can include instructions 216, extravascular image 218, image speed map 220, point A on image 222, shortest paths to point A 224, point B on image 226, path between A and B 228, and image with path overlay 230.

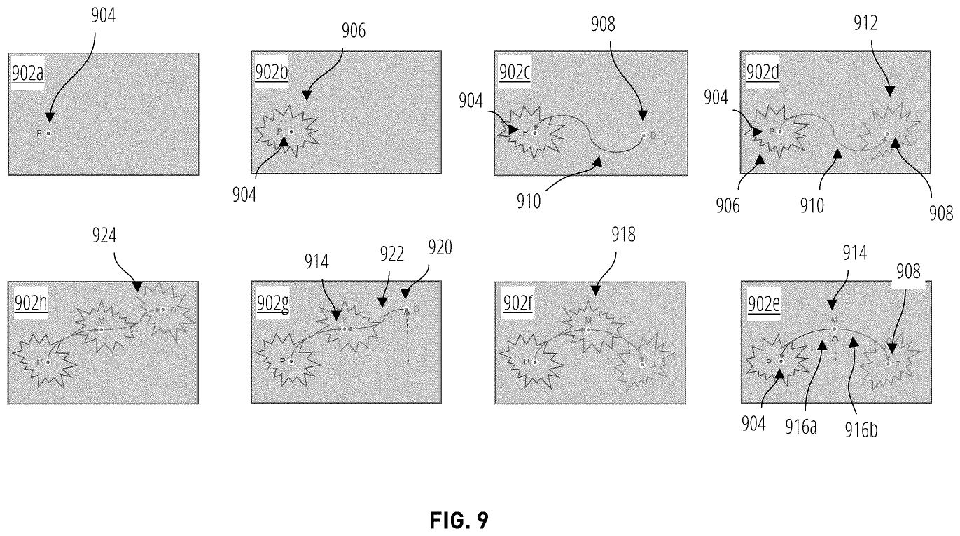

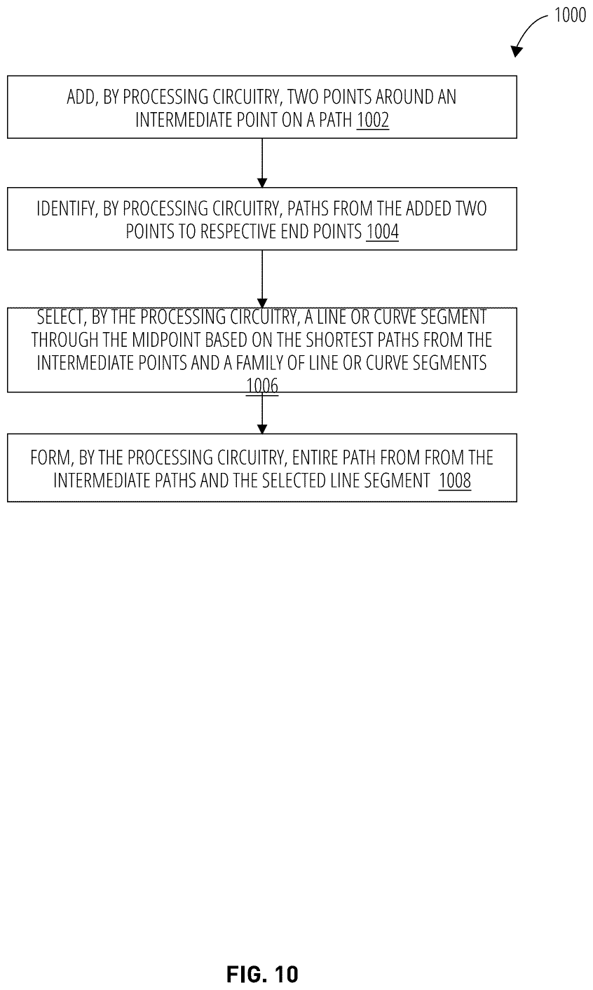

It is important to note that although point A 222 and point B 226 are often referred to singularly, point A on image 222 and point B on image 226 as well as the path between A and B 228 are not singletons but make up a single leg of an overall path, which path can have multiple legs. As such, many embodiments of the disclosure contemplate multiple points A on image 222 and multiple points B on image 226 (e.g., see FIG. 9 and FIG. 10) as well as multiple paths, or “legs” of a path. To that end, these elements are depicted in plural form in FIG. 2. With some embodiments, processor 208 can execute instructions 216 to receive (e.g., from a user via I/O) these points and store the points in memory 210. Similarly, memory 210 can store a set of shortest paths to each respective point of points A 224 and a path (e.g., in paths between A and B 228) between each adjacent pair of points in points A on image 222 and points B on image 226.

With some embodiments, processor 208 can execute instructions 216 to identify points A on image 222 and points B on image 226 using a machine learning (ML) model. For example, an ML model (not shown) could be trained to infer pixels corresponding to a vessel from an angiogram image (e.g., using a supervised training algorithm, an unsupervised training algorithm, or the like). Subsequently, the trained ML model could be deployed such that during operation, points A on image 222 and points B on image 226 can be inferred from extravascular image 218.

An example of multiple points and paths is provided in more detail in FIG. 9 below. However, in the interest of clarity, an example of multiple legs of a path is given here. FIG. 9 depicts shortest paths 916a and 916b, which are two instances of path between A and B 228. That is, first point 904 and second point 908 are instances of point A on image 222 while third point 914 represents two instances of point B on image 226.

During operation, processor 208 can execute instructions 216 to cause computing device 202 to receive extravascular image 218 from imager 204. Processor 208 can further execute instructions 216 to generate image speed map 220 from extravascular image 218, receive (or infer) an indication of point A on image 222 and generate shortest paths to point A 224 from all points on image 222 and image speed map 220. Further, processor 208 can execute instructions 216 to receive (or infer) point B on image 226 and identify path between A and B 228 from point B on image 226 and shortest paths to point A 224. Further, processor 208 can execute instructions 216 to generate image with path overlay 230 and cause image with path overlay 230 to be displayed on display 206.

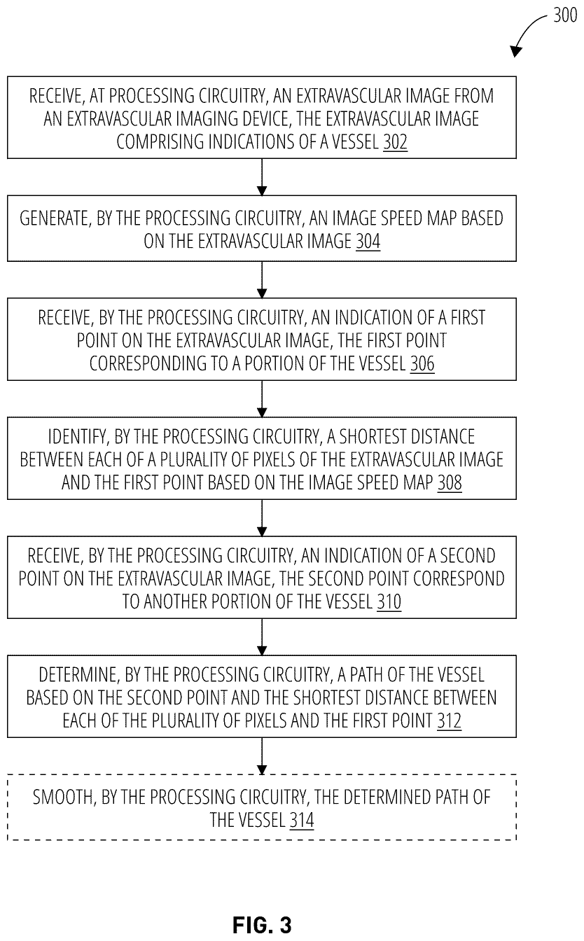

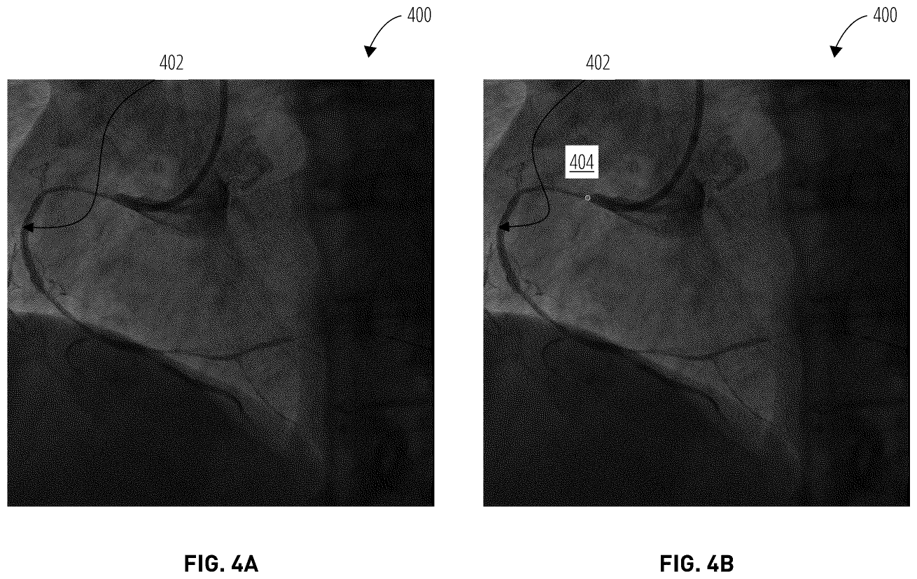

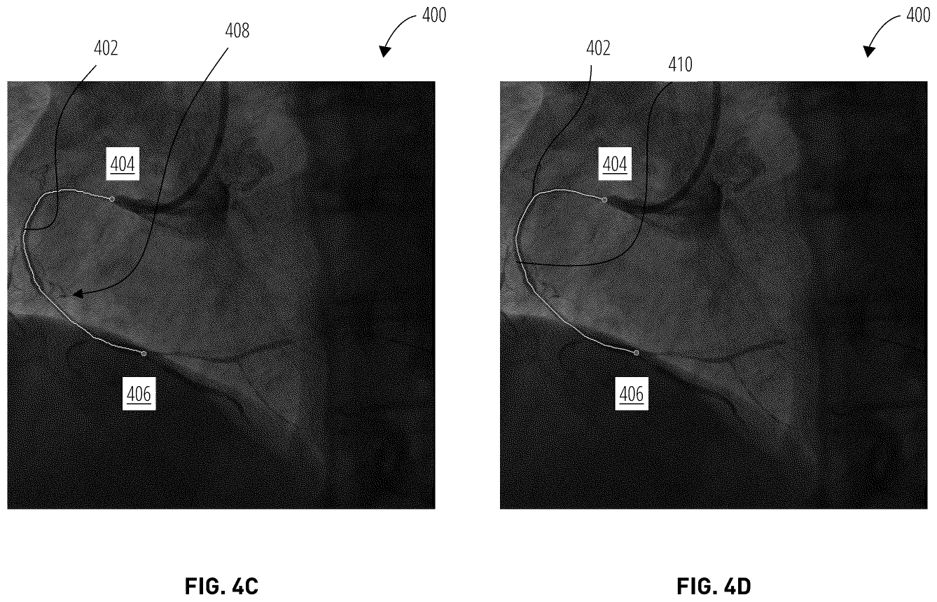

FIG. 3 illustrates a logic flow 300 that can be implemented by a computing device coupled to an extravascular imaging device, according to at least one embodiment of the present disclosure. The logic flow 300 could be implemented by computing device 106 of combined internal and external imaging system 100 of FIG. 1 or by computing device 202 of vessel path identification system 200 of FIG. 2. It is noted that for purposes of clarity, logic flow 300 is described with reference to computing device 202 of vessel path identification system 200 of FIG. 2 and FIG. 4A to FIG. 4D. FIG. 4A to FIG. 4D illustrate an extravascular image as well as points indicated on the extravascular image and a path of a vessel represented in the extravascular image. This is described in greater detail below.

Logic flow 300 can begin at block 302. At block 302 “receive, at processing circuitry, an extravascular image from an extravascular imaging device, the extravascular image comprising indications of a vessel” an extravascular image comprising indications of a vessel can be received at processing circuitry of a computing device. For example, processor 208 can execute instructions 216 to receive extravascular image 218 from imager 204 (e.g., c-arm 110, or the like) where extravascular image 218 is an extravascular image (e.g., angiogram, fluoroscope image, or the like). For example, extravascular image 218 can be like extravascular image 400 depicted in FIG. 4A. As depicted extravascular image 400 includes a representation of vessel 402. With some embodiments, processor 208 can execute instructions 216 to cause extravascular image 218 to be displayed as part of a graphical user interface (GUI) 232 shown on display 206. With some embodiments, processor 208 can execute instructions 216 provide the GUI 232 to allow a user (e.g., physician, or the like) to view the angiogram (e.g., extravascular image 218) and add, move, and/or delete points and to view the vessel shape (e.g., path) in real-time as the points are added, moved, or deleted.

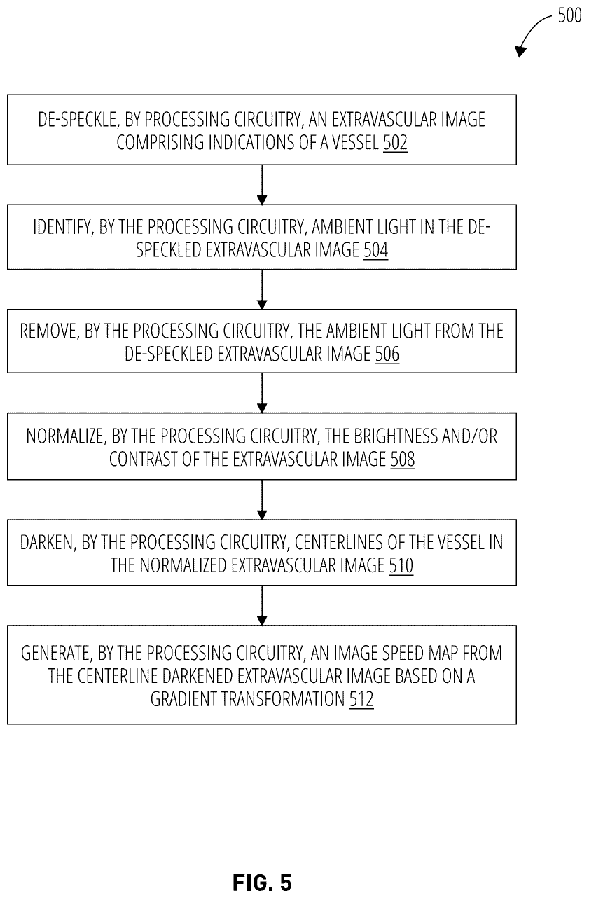

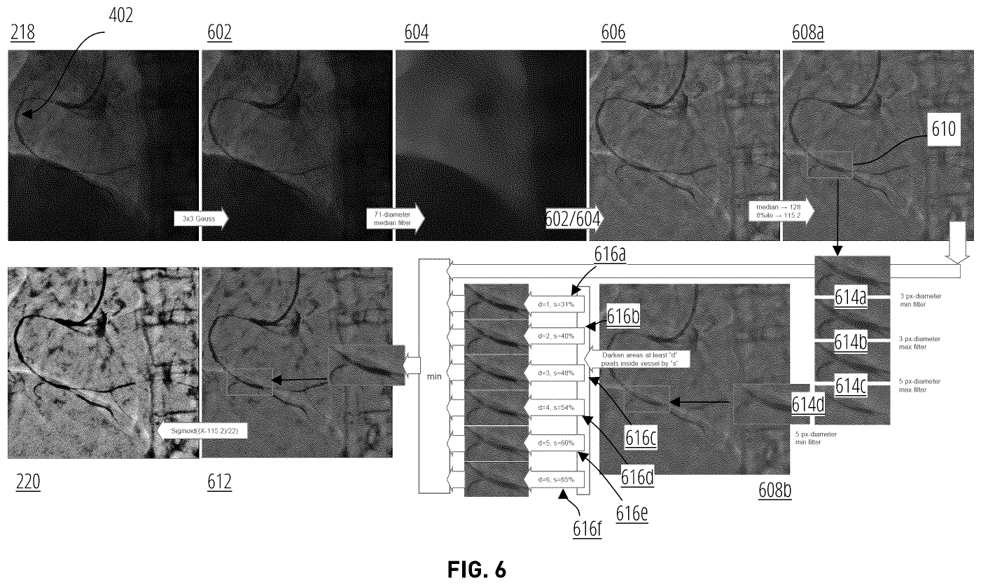

Continuing to block 304 “generate, by the processing circuitry, an image speed map based on the extravascular image” an image speed map can be generated by the processing circuitry. For example, processor 208 can execute instructions 216 to generate image speed map 220 from extravascular image 218. Examples of an image speed map are described below (e.g., FIG. 5 and FIG. 6). However, in general, image speed map 220 comprises a copy of extravascular image 218 where the contrast of the image has been adjusted to prominently distinguish between the vessel represented in extravascular image 218 and other parts of the extravascular image 218.

Continuing to block 306 “receive, by the processing circuitry, an indication of a first point on the extravascular image, the first point corresponding to a portion of the vessel” a point on the extravascular image corresponding to a location on (or portion of) the vessel can be received by the processing circuitry. For example, processor 208 can execute instructions 216 to receive point A on image 222 (e.g., from a user via input and/or output (I/O) devices 212, or the like). In some embodiments, a physician can designate point A on image 222 (e.g., a proximal point) of the vessel on the extravascular image 218) using a touch screen, a mouse, a joystick, or the like. FIG. 4B illustrates extravascular image 400 and vessel 402 with a point 404 (e.g., point A on image 222) on the vessel 402 marked on extravascular image 400. With some embodiments, processor 208 can execute instructions 216 to cause GUI 232 to include indications of the extravascular image 218 with the point A on image 222 marked on the image.

Continuing to block 308 “identify, by the processing circuitry, a shortest distance between each of a plurality of pixels of the extravascular image and the first point based on the image speed map” a shortest distance between the point received at block 306 and a plurality of pixels of the extravascular image can be determined. It is to be appreciated that the term “shortest distance” as used herein is not the shortest straight-line distance but is instead the shortest path or the shortest distance along a path or a vessel.

For example, in some embodiments, processor 208 can execute instructions 216 to identify the shortest path between point A on image 222 and a plurality of other pixels of extravascular image 218. In some embodiments, processor 208 executes instructions 216 to identify paths between point A on image 222 and each pixel associated with the vessel of extravascular image 218 (e.g., vessel 402, or the like) based on the image speed map 220. In some embodiments, processor 208 executes instructions 216 to identify shortest paths to point A 224 between point A on image 222 and each pixel of extravascular image 218 (e.g., vessel 402, or the like) based on the image speed map 220. With some embodiments, processor 208 can execute instructions 216 to identify the paths based on a path-finding algorithm, such as, for example, Dijkstra's Algorithm. With such embodiments, processor 208 can execute instructions 216 to derive the paths using the path-finding algorithm based on the image speed map 220 with a priority queue (e.g., Fibonacci Heap, or the like).

In some embodiments, block 308 can include (e.g., as a precursor block, or implicitly embodied in block 308) converting the image speed map 220 to a cost graph (not shown). The cost graph can be used to identify the shortest distance between each of the plurality of pixels of the extravascular image and the first point. For example, a path-finding algorithm (e.g., Dijkstra's Algorithm, or the like) can use the cost graph to identify the least costly path as the shortest path. It is to be appreciated that a graph as used herein is a graph in the mathematical sense, which consists of nodes and edges. In some embodiments, each node represents a pixel in the speed map while each edge represents a connection between neighboring pixels and the associated cost to travel between the neighbors. The edge cost values are based on the speed values of the pixels travelled and the length of the edge. The number of edges (e.g., neighbors) per node (e.g., pixel) can vary, but generally they will be 4, 8, 16, 24, 32, or the like.

Continuing to block 310 “receive, by the processing circuitry, an indication of a second point on the extravascular image, the second point correspond to another portion of the vessel” a second point on the extravascular image corresponding to a location on (or portion of) the vessel can be received by the processing circuitry. For example, processor 208 can execute instructions 216 to receive point B on image 226 (e.g., from a user via input and/or output (I/O) devices 212, based on inference using an ML model, or the like). In some embodiments, a physician can designate shortest paths to point A 224 (e.g., a distal point) of the vessel on the extravascular image 218) using a touch screen, a mouse, a joystick, or the like. FIG. 4C illustrates extravascular image 400 and vessel 402 with point 404 (e.g., point A on image 222) as well as point 406 (e.g., point B on image 226) on the vessel 402 marked on extravascular image 400. With some embodiments, processor 208 can execute instructions 216 to cause GUI 232 to include indications of the extravascular image 218 with the point A on image 222 and point B on image 226 marked on the image.

Continuing to block 312 “determine, by the processing circuitry, a path of the vessel based on the second point and the shortest distance between each of the plurality of pixels and the first point” a path between the point received at block 306 and the point received at block 310 can be determined based on the paths identified at block 308. For example, processor 208 can execute instructions 216 to identify the path from shortest paths to point A 224 associated with point B on images 226 and generate image with path overlay 230 from extravascular image 218 and path between A and B 228. FIG. 4C illustrates extravascular image 400 with vessel 402, point 404, point 406, and path between points 408 marked on the extravascular image 400. With some embodiments, processor 208 can execute instructions 216 to cause GUI 232 to include indications of the extravascular image 218 with the point A on image 222, point B on image 226, and path between A and B 228 marked on the image. With some embodiments, processor 208 can execute instructions 216 to cause the GUI 232 to include indications of both point B on image 226 and path between A and B 228 simultaneously.

Logic flow 300 can optionally continue to block 314 “smooth, by the processing circuitry, the determined path of the vessel” where the path of the vessel determined at block 312 can be smoothed. For example, processor 208 can execute instructions 216 to smooth (e.g., remove jagged sections, reduce extraneous length, etc. In some embodiments, processor 208 can execute instructions 216 to smooth path between A and B 228 based on a path-smoothing algorithm and generate image with path overlay 230 from extravascular image 218 and the smoothed path between A and B 228. FIG. 4D illustrates extravascular image 400 with vessel 402, point 404, point 406, and smoothed path 410 marked on the extravascular image 400. With some examples, processor 208 can execute instructions 216 to smooth the path based on the Douglas-Peuker Algorithm, based on a path sampling algorithm (e.g., sample every nth coordinate (e.g., 4th, 5th, 6th, 7th, etc.), based on a spline simplification algorithm, or the like.

FIG. 5 illustrates a logic flow 500 that can be implemented by a computing device coupled to an extravascular imaging device to generate an image speed map, according to at least one embodiment of the present disclosure. With some embodiments, logic flow 300 could implement logic flow 500 as part of block 304. The logic flow 500 could be implemented by computing device 106 of combined internal and external imaging system 100 of FIG. 1 or by computing device 202 of vessel path identification system 200 of FIG. 2. It is noted that for purposes of clarity, logic flow 500 is described with reference to computing device 202 of vessel path identification system 200 of FIG. 2 and FIG. 6. FIG. 6 illustrates a series of extravascular images transformed to form an image speed map, according to at least one embodiment of the present disclosure.

With some embodiments, processor 208 can execute instructions 216 to implement logic flow 500 “in the background” while a user (e.g., physician) analyzes GUI 232 depicting extravascular image 218. Logic flow 500 can begin at block 502. At block 502 “de-speckle, by processing circuitry, an extravascular image comprising indications of a vessel” the extravascular image can be de-speckled. For example, processor 208 can execute instructions 216 to de-speckle the extravascular image 218 to form a de-speckled extravascular image. As noted above, FIG. 6 illustrates a series of extravascular images illustrating generating an image speed map 220 from extravascular image 218. To this end, FIG. 6 illustrates de-speckled image 602 formed from extravascular image 218. Further, as depicted extravascular image 218 includes indications of vessel 402. With some embodiments, processor 208 can execute instructions 216 to apply a Gaussian filter to extravascular image 218 to form de-speckled image 602. For example, processor 208 can execute instructions 216 to apply a 3 pixel by 3 pixel Gaussian kernel to extravascular image 218 to form de-speckled image 602.

Continuing to block 504 “identify, by the processing circuitry, ambient light in the de-speckled extravascular image” ambient light in the de-speckled image can be identified. For example, processor 208 can execute instructions 216 to identify ambient light in de-speckled image 602 based on a blurring filter (e.g., 30-120 pixel diameter median filter, or the like). FIG. 6 illustrates ambient light of extravascular image 604 showing detected or identified ambient light from de-speckled image 602. Continuing to block 506 “remove, by the processing circuitry, the ambient light from the de-speckled extravascular image” the identified ambient light can be removed from the de-speckled image. For example, processor 208 can execute instructions 216 to remove ambient light of extravascular image 604 from de-speckled image 602 to form light adjusted extravascular image 606. FIG. 6 illustrates light adjusted extravascular image 606 formed from de-speckled image 602 and ambient light of extravascular image 604.

With some other embodiments, the blurring filter can be in the form of a geometric shape (e.g., a circle), which is applied across the entire image. With other embodiments, multiple filters can be provided with different filters applied across (or to) different areas of the image. For example, a first filter can be applied to the borders or edges of an image to remove any shadows or dark borders, after which another filter can be applied across the image as outlined above.

Continuing to block 508 “normalize, by the processing circuitry, the brightness and/or contrast of the ambient light adjusted extravascular image” the brightness and/or contrast of the ambient light adjusted extravascular image can be normalized. For example, processor 208 can execute instructions 216 to normalize the brightness and/or ambient light of the light adjusted extravascular image 606 to form normalized extravascular image 608a. With some embodiments, processor 208 can execute instructions 216 to apply an image normalization algorithm to light adjusted extravascular image 606 to form normalized extravascular image 608a. FIG. 6 illustrates normalized extravascular image 608a formed from light adjusted extravascular image 606.

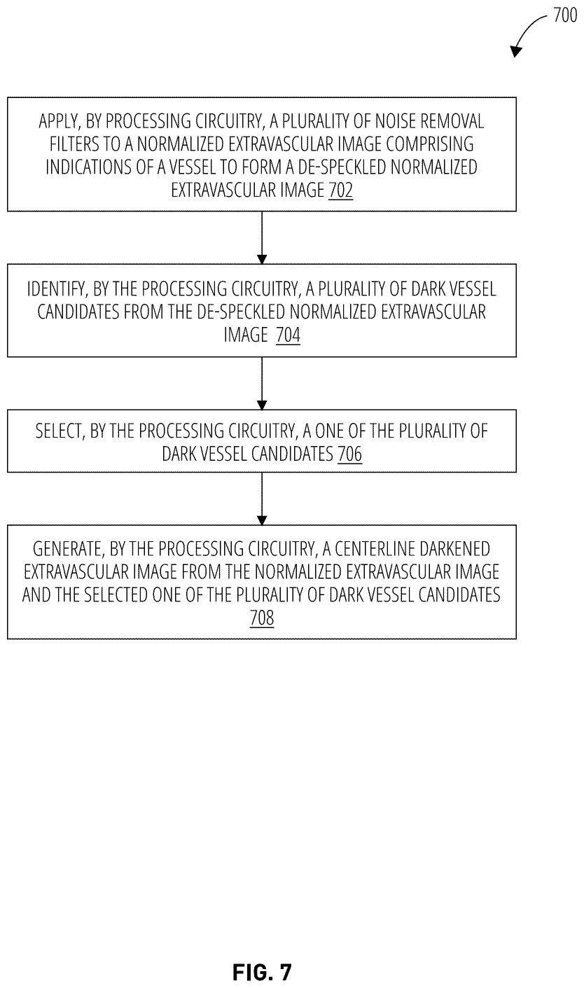

Continuing to block 510 “darken, by the processing circuitry, centerlines of the vessel in the normalized extravascular image” centerlines of the vessel in the normalized extravascular image can be darkened to form a centerline darkened extravascular image. For example, processor 208 can execute instructions 216 to generate centerline darkened extravascular image 612 from normalized extravascular image 608a by darkening portions of the vessel represented in image 608a. In general, portions of the vessel 402 are progressive darkened with the centerline of the vessel 402 darkened at a higher rate than edges of the vessel 402. This is described in greater detail with reference to region 610 for purposes of clarity. However, it is to be appreciated that the entire image 608a is processed as described to darken portion of the vessel 402. Processor 208 can execute instructions 216 to apply a series of filters (e.g., 3 pixel diameter minimum filter, 3 pixel diameter maximum filter, 5 pixel diameter maximum filter, and 5 pixel diameter minimum filter, or the like) across normalized extravascular image 608a to progressively darken areas further from the edges of the vessel to darken the centerline of the vessel. FIG. 6 illustrates region 610 on normalized extravascular image 608a and centerline darkened extravascular image 612 and a series of filters applied to the normalized extravascular image 608a highlighted by region 610. This is described in greater detail below, with respect to FIG. 7.

Continuing to block 512 “generate, by the processing circuitry, an image speed map from the centerline darkened extravascular image based on a gradient transformation” an image speed map can be generated from the centerline darkened extravascular image based on a gradient transformation. For example, processor 208 can execute instructions 216 to apply a transformation (e.g., gradient transformation, linear transformation, sigmoid transformation, or the like) to centerline darkened extravascular image 612 to form image speed map 220. In some embodiments, processor 208 can execute instruction 216 to apply a sigmoid function (e.g., Sigmoid (X-115.2)/22)) to centerline darkened extravascular image 612 to form image speed map 220. In other embodiments, processor 208 can execute instructions 216 to apply a linear function saturated as min and max values to centerline darkened extravascular image 612 to form image speed map 220.

FIG. 7 illustrates a logic flow 700 for applying a mask to a normalized extravascular image to darken the centerline of a vessel or vessels in the normalized extravascular image. Logic flow 700 can be implemented by a computing device coupled to an extravascular imaging device, according to at least one embodiment of the present disclosure. With some embodiments, logic flow 500 could implement logic flow 700 as part of block 510. The logic flow 700 could be implemented by computing device 106 of combined internal and external imaging system 100 of FIG. 1 or by computing device 202 of vessel path identification system 200 of FIG. 2. It is noted that for purposes of clarity, logic flow 700 is described with reference to computing device 202 of vessel path identification system 200 of FIG. 2 and FIG. 6. As described above, FIG. 6 illustrates a series of extravascular images transformed to form an Image speed map, according to at least one embodiment of the present disclosure.

Logic flow 700 can begin at block 702. At block 702 “apply, by processing circuitry, a plurality of noise removal filters to a normalized extravascular image comprising indications of a vessel to form a de-speckled normalized extravascular image” several noise removal filters can be applied to a normalized extravascular image to form a de-speckled normalized extravascular image. For example, processor 208 can execute instructions 216 to apply filters (e.g., filter 614a, filter 614b, filter 614c, and/or filter 614d) to normalized extravascular image 608a to form de-speckled normalized extravascular image 608b. In some embodiments, filters 614a, 614b, 614c, and 614d can comprise morphological opening and closing filters. As a specific example, processor 208 can execute instructions 216 to sequentially apply a morphological opening filter of the dark pixels and then a morphological closing filter of the dark pixels. With some embodiments, processor 208 can execute instructions 216 to apply the morphological opening filter of the dark pixels using a 3 pixel by 3 pixel circular structuring element and apply first a minimum filter (e.g., filter 614a) and then a maximum filter (e.g., filter 614b). Further, with some embodiments, processor 208 can execute instructions 216 to apply the morphological closing filter of the dark pixels using a 5 pixel by 5 pixel circular structuring element and apply first a maximum filter (e.g., filter 614c) and then a minimum filter (e.g., filter 614d).

Continuing to block 704 “identify, by the processing circuitry, a plurality of dark vessel candidates from the de-speckled normalized extravascular image” several dark vessel candidates can be identified from the de-speckled normalized extravascular image. For example, processor 208 can execute instructions 216 to identify dark vessel candidate 616a, dark vessel candidate 616b, dark vessel candidate 616c, dark vessel candidate 616d, dark vessel candidate 616e, and/or dark vessel candidate 616f from de-speckled normalized extravascular image 608b by darkening areas at least d pixels inside vessel by an amount s. Processor 208 can execute instructions 216 to identify dark vessel candidate 616a by darkening areas at least d pixels inside vessel by multiplying pixel values by an amount s, where d=1 and s=0.31. Processor 208 can execute instructions 216 to identify dark vessel candidate 616b by darkening areas at least d pixels inside vessel by multiplying pixel values by an amount s, where d=2 and s=0.40. Processor 208 can execute instructions 216 to identify dark vessel candidate 616c by darkening areas at least d pixels inside vessel by multiplying pixel values by an amount s, where d=3 and s=0.48. Processor 208 can execute instructions 216 to identify dark vessel candidate 616d by darkening areas at least d pixels inside vessel by multiplying pixel values by an amount s, where d=4 and s=0.54. Processor 208 can execute instructions 216 to identify dark vessel candidate 616e by darkening areas at least d pixels inside vessel by multiplying pixel values by an amount s, where d=5 and s=0.60. Processor 208 can execute instructions 216 to identify dark vessel candidate 616a by darkening areas at least d pixels inside vessel by multiplying pixel values by an amount s, where d=6 and s=0.65.

With some embodiments, processor 208 can execute instructions 216 to identify dark vessel candidates (e.g., dark vessel candidates 616a, 616b, etc.) based on the following:
Generate a thin vessel image (not shown) by performing a morphological dilation with a max filter on de-speckled normalized extravascular image 608b using a w*h circular structuring element, where w=2d+1 and h=2d+1;
Calculate soft vessel probability image (not shown) from the thin vessel image by applying a sigmoid-like function f(x) to each pixel of the thin vessel image, where f(x)={0, if x<=103.68 1, if x>=126.72 (x−103.68)/23.04, if 103.68<x<126.72};
Calculate a darker thin vessel image (not shown) from the thin vessel image by multiplying each pixel value by s; and
Calculate dark vessel candidates (e.g., dark vessel candidates 616a, 616b, etc.) by alpha-blending normalized extravascular image 608a and the darker thin vessel image using the soft vessel probability image as the alpha channel, where alpha=0 means 100% pixel value of the thin vessel image and alpha=1 means 100% pixel value of normalized extravascular image 608a.

Continuing to block 706 “select, by the processing circuitry, a one of the plurality of dark vessel candidates” a one of the plurality of dark vessel candidates (e.g., de-speckled normalized extravascular image 608b, dark vessel candidates 616a, 616b, etc.) can be selected. For example, processor 208 can execute instructions 216 to select the one of the dark vessel candidates (e.g., de-speckled normalized extravascular image 608b, dark vessel candidates 616a, 616b, etc.) having the minimum (e.g., darkest) pixels.

Continuing to block 708 “generate, by the processing circuitry, a centerline darkened extravascular image from the normalized extravascular image and the selected one of the plurality of dark vessel candidates” a centerline darkened extravascular image can be generated from the normalized extravascular image and the selected one of the plurality of dark vessel candidates. It is to be appreciated that the selection of one of the dark vessel candidates can be made for each masked area or region of the image. As such, logic flow 700 can be iteratively performed across the entire normalized extravascular image 608a (e.g., as described above with respect to region 610).

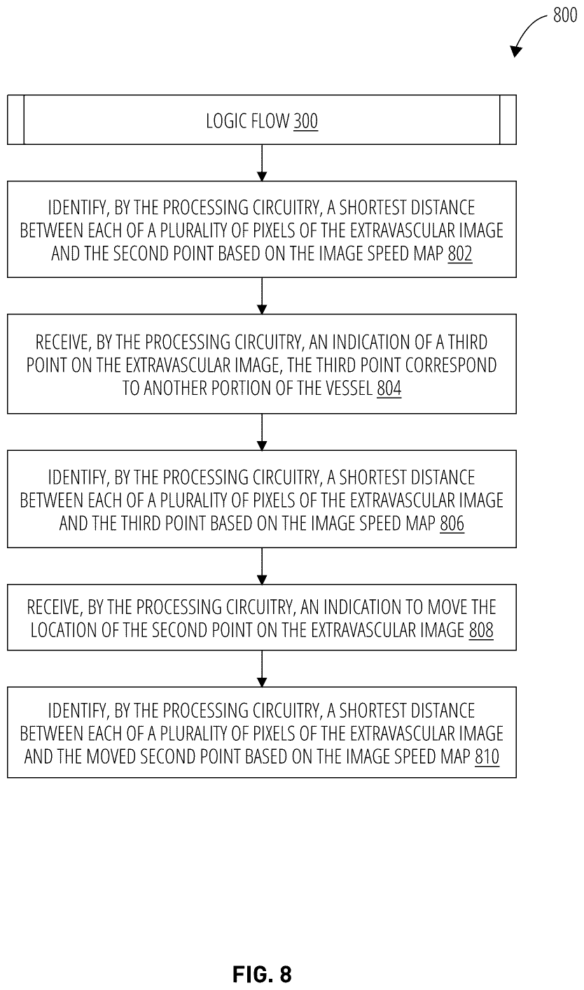

Returning to FIG. 2. As described above, memory 210 stores shortest paths to point A 224, which comprises an indication of the shortest path between point A on image 222 and several other pixels (or points) of extravascular image 218. With some embodiments, shortest paths to point A 224 can be a list referencing each of the determined shortest paths (e.g., between point A and pixel 1, between point A and pixel 2, between point A and pixel 3, etc.). Accordingly, during operation, if the user moves, adds, or deletes a point (e.g., user moves point B, or the like) then processor 208 can execute instructions 216 to update (e.g., in real-time as the point is moved, added, or deleted) path between A and B 228. FIG. 8 illustrates a logic flow 800 that can be implemented by a computing device coupled to an extravascular imaging device to display a path and/or update a path as contemplated herein. The logic flow 800 could be implemented by computing device 106 of combined internal and external imaging system 100 of FIG. 1 or by computing device 202 of vessel path identification system 200 of FIG. 2. It is noted that for purposes of clarity, logic flow 800 is described with reference to computing device 202 of vessel path identification system 200 of FIG. 2 and FIG. 9. FIG. 9 illustrates a series of extravascular images showing points, a path between the points, which can be like the points and path displayed on an extravascular image (e.g., extravascular image 218) and shown on a GUI (e.g., GUI 232) for a user.

Logic flow 800 can begin at logic flow 300. That is, logic flow 800 can include as a first sub-process, logic flow 300. As described above, logic flow 300 can be implemented to receive points on an extravascular image and determine a path between the points. FIG. 9 illustrates a series of image 902a through image 902h highlighting points and path between the points. It is noted that these images can be extravascular images. However, for purposes of clarity, the depictions or indications of the vessel and vascular structure are omitted so that the disclosure can focus on the points and path between points. As described above, logic flow 300 includes block 306 where a point on the image can be received. FIG. 9 illustrates image 902a showing first point 904 received and denoted on the image. Logic flow 300 further includes block 308 where all paths between a point and other points on the image are identified (or derived using a shortest-path algorithm, or the like). For example, FIG. 9 illustrates image 902b showing first point 904 and shortest paths to first point 906 between first point 904 and other points of the image being identified. Logic flow 300 further includes block 310 and block 312 where a second point on the image is received and the shortest path between the first point and the second point is identified. FIG. 9 illustrates image 902c showing second point 908 received and denoted on the image as well as the shortest path 910 between first point 904 and second point 908 depicted on the image. As described above, the shortest path 910 can be retrieved from the shortest paths to point A 224 that is derived previously. As such, the shortest path 910 can be depicted and denoted on the image in real-time.

Logic flow 800 can continue from logic flow 300 to block 802. At block 802 “identify, by the processing circuitry, a shortest distance between each of a plurality of pixels of the extravascular image and the second point based on the image speed map” a shortest distance between the second point and a plurality of pixels of the extravascular image can be determined. For example, in some embodiments, processor 208 can execute instructions 216 to identify the shortest path between point B on image 226 and a plurality of other pixels of extravascular image 218. In some embodiments, processor 208 executes instructions 216 to identify paths between point B on image 226 and each pixel associated with the vessel of extravascular image 218 (e.g., vessel 402, or the like) based on the image speed map 220. FIG. 9 illustrates image 902d showing both first point 904 and second point 908 as well as the shortest paths to first point 906 and shortest paths to second point 912.

It is to be appreciated that once shortest paths to first point 906 and shortest paths to second point 912 are derived, then the shortest path 910 can be updated in real-time based on movement of either first point 904 or second point 908. Further, addition of a point between first point 904 or second point 908 can result in an update to shortest path 910 in real-time.

Logic flow 800 can continue to block 804 “receive, by the processing circuitry, an indication of a third point on the extravascular image, the third point corresponding to a portion of the vessel” a point on the extravascular image corresponding to a location on (or portion of) the vessel can be received by the processing circuitry. For example, processor 208 can execute instructions 216 to receive a third point 914 (e.g., from a user via input and/or output (I/O) devices 212, based on inference using an ML model, or the like) and display the shortest paths from the third point 914 to first point 904 and second point 908. FIG. 9 illustrates image 902c showing the third point 914 as well as updated shortest path 916a as the shortest path from third point 914 to first point 904 and updated shortest path 916b as the shortest path between third point 914 and second point 908. The combined path of updated shortest path 916a and updated shortest path 916b forms the shortest path from first point 904 to second point 908 that traverses through third point 914. In this manner, a user (e.g., physician, or the like) can add a point to an extravascular image (e.g., extravascular image 218) and have the path updated in real-time to account for the added point.

Continuing to block 806 “identify, by the processing circuitry, a shortest distance between each of a plurality of pixels of the extravascular image and the third point based on the image speed map” a shortest distance between the third point and a plurality of pixels of the extravascular image can be determined. For example, in some embodiments, processor 208 can execute instructions 216 to identify the shortest path between third point 914 and a plurality of other pixels of the image. FIG. 9 illustrates image 902f showing the shortest paths to third point 918.

Continuing to block 808 “receive, by the processing circuitry, an indication to move the location of the second point on the extravascular image and update the shortest path” an indication to move the location of the second point on the image can be received. For example, processor 208 can execute instructions 216 to receive an indication (e.g., from a user via I/O devices 212, based on inference using an ML model, or the like) to move the location of one of the points on the image (e.g., second point 908, or the like) and update the shortest path in real-time. For example, FIG. 9 illustrates image 902g showing second point 908 moved to moved second point 920 and updated shortest path 916b updated to updated shortest path 922 in real-time. Processor 208 can execute instructions 216 to determine updated shortest path 922 from the shortest paths to third point 918 and moved second point 920.

Continuing to block 810 “identify, by the processing circuitry, a shortest distance between each of a plurality of pixels of the extravascular image and the moved second point based on the image speed map” a shortest distance between the moved second point and a plurality of pixels of the extravascular image can be determined. For example, in some embodiments, processor 208 can execute instructions 216 to identify the shortest path between moved second point 920 and a plurality of other pixels of the image. FIG. 9 illustrates image 902h showing the shortest paths to moved second point 924.

Accordingly, logic flow 800 can be implemented to provide that points can be added, removed, moved, or the like and the path between points updated in real-time and displayed on a GUI (e.g., GUI 232) for a user.

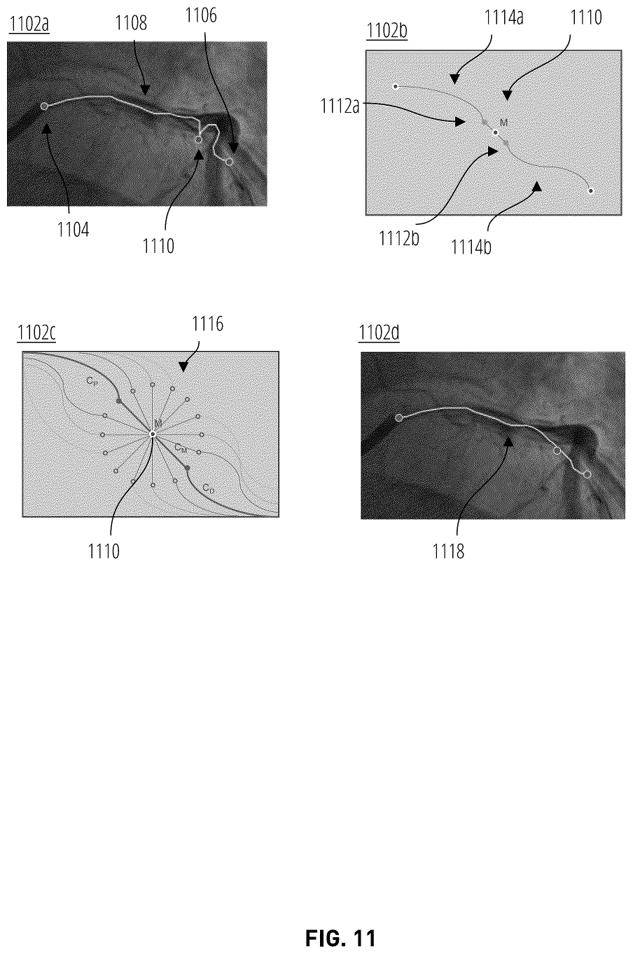

FIG. 10 illustrates a logic flow 1000 that can be implemented by a computing device coupled to an extravascular imaging device to smooth a path around an intermediate point as contemplated herein. The logic flow 1000 could be implemented by computing device 106 of combined internal and external imaging system 100 of FIG. 1 or by computing device 202 of vessel path identification system 200 of FIG. 2. It is noted that for purposes of clarity, logic flow 1000 is described with reference to computing device 202 of vessel path identification system 200 of FIG. 2 and FIG. 11. FIG. 11 illustrates a series of extravascular images showing points, a path between the points, which can be like the points and path displayed on an extravascular image (e.g., extravascular image 218) and shown on a GUI (e.g., GUI 232) for a user.

Logic flow 1000 can begin at block 1002 “add, by processing circuitry, two intermediate points around a midpoint on a path” where two intermediate points are added around a midpoint on a path. For example, processor 208 can execute instructions 216 to add intermediate point on either side of a midpoint on a path. With some embodiments, processor 208 executes instructions 216 to add the intermediate points a specified number of pixels (e.g., between 5 and 20, 12 pixels, or the like) away from the midpoint along the routed path. FIG. 11 illustrates image 1102a showing proximal point 1104 and distal point 1106 with path 1108 routed between proximal point 1104 and distal point 1106 through a midpoint 1110. Further, FIG. 11 illustrates image 1102b showing intermediate point 1112a and intermediate point 1112b added along path 1108 on either side of midpoint 1110.

Continuing to block 1004 “identify, by processing circuitry, paths from the intermediate points to respective end points” paths from the intermediate points to respective end points can be identified. For example, processor 208 can execute instructions 216 to identify paths from each intermediate point to respective end points based on previously determined shortest paths for each end point (e.g., shortest paths to point A 224, etc.). FIG. 11 illustrates image 1102b showing intermediate point 1112a and intermediate point 1112b added around path 1108 and shortest path 1114a routed between intermediate point 1112a and its respective endpoint as well as shortest path 1114b routed between intermediate point 1112b and its respective endpoint.

Continuing to block 1006 “select, by the processing circuitry, a line or curve segment through the midpoint based on the shortest paths from the intermediate points and a family of line or curve segments” a line or curve segment can be identified based on the shortest paths from the intermediate points and a family of line or curve segments. For example, processor 208 can execute instructions 216 to identify a line or curve segment from a family of line or curve segments based on the paths routed from the intermediate points. With some embodiments, processor 208 can execute instructions 216 to identify the line or curve segment based on minimizing the cost of the entire path. For example, FIG. 11 illustrates image 1102c showing a family of line or curve segments 1116 passing through midpoint 1108. Processor 208 can execute instructions 216 to evaluate such a plurality of line or curve segments and select the line or curve segment with the minimum total path cost (e.g., selected path=minimum of (C_{P}+C_{M}+C_{D}), wherein C_{M} is the line or curve segment through the midpoint). With some embodiments, processor 208 can execute instructions 216 to evaluate a family of line or curve segments 1116 that includes lines passing proximate to the midpoint 1110 (to allow for inaccurately placed points) and/or curved line or curve segments (to follow bending vessels).

Continuing to block 1008 “form, by the processing circuitry, entire path from the intermediate paths and the selected line or curve segment” a complete path through the midpoint is formed from the paths routed from the intermediate points and the selected line or curve segment. For example, processor 208 can execute instructions 216 to form a complete path from the paths routed from the intermediate midpoints at block 1004 and the line or curve or curve segment selected at block 1006. FIG. 11 illustrates image 1102d showing a smoothed path 1118 formed from the intermediate point 1112a, intermediate point 1112b, and the line or curve segment selected from line or curve segments 1116.

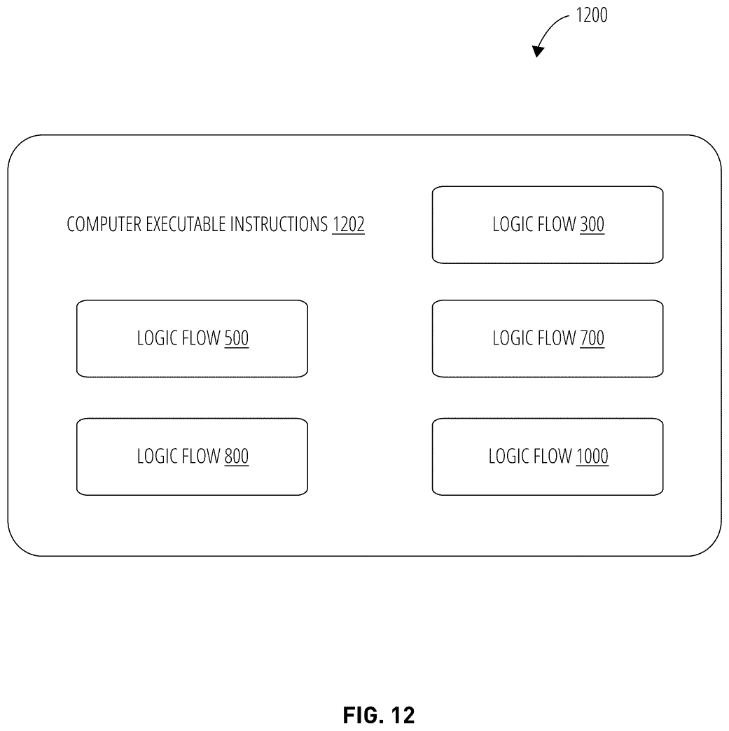

FIG. 12 illustrates computer-readable storage medium 1200. Computer-readable storage medium 1200 may comprise any non-transitory computer-readable storage medium or machine-readable storage medium, such as an optical, magnetic or semiconductor storage medium. In various embodiments, computer-readable storage medium 1200 may comprise an article of manufacture. In some embodiments, computer-readable storage medium 1200 may store computer executable instructions 1202 with which circuitry (e.g., computing device 106, processor 208, or the like) can execute. For example, computer executable instructions 1202 can include instructions to implement operations described with respect to logic flow 300, logic flow 500, logic flow 700, logic flow 800 and/or logic flow 1000. Examples of computer-readable storage medium 1200 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 1202 may include any suitable type of code, such as source code, compiled code, interpreted code, executable code, static code, dynamic code, object-oriented code, visual code, and the like.

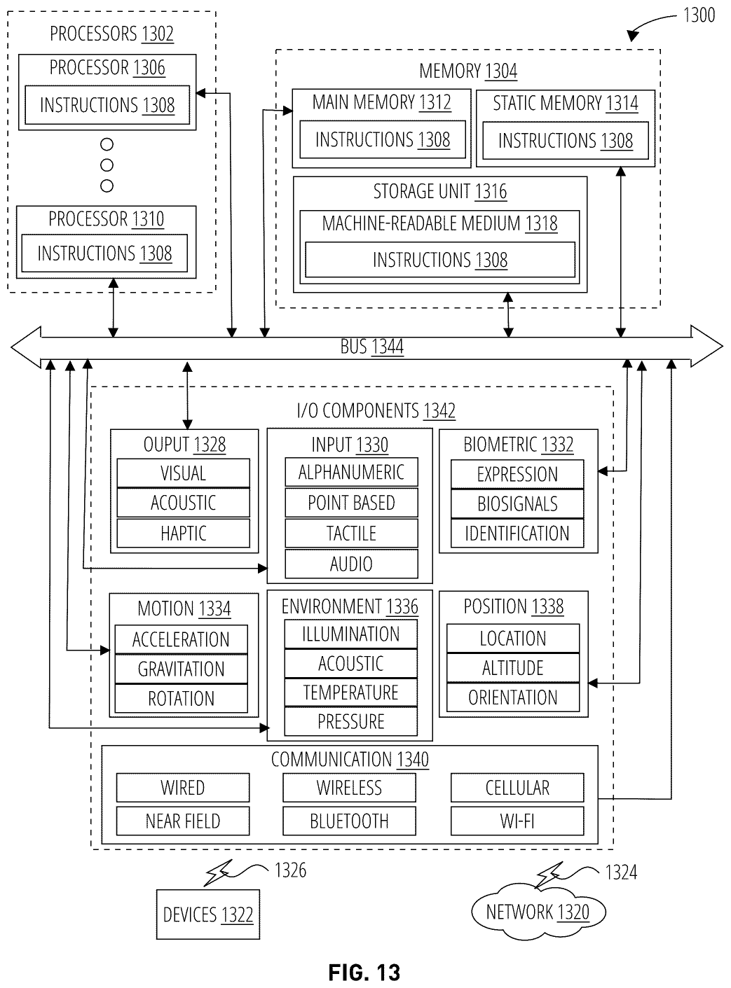

FIG. 13 illustrates a diagrammatic representation of a machine 1300 in the form of a computer system within which a set of instructions may be executed for causing the machine to perform any one or more of the methodologies discussed herein. More specifically, FIG. 13 shows a diagrammatic representation of the machine 1300 in the example form of a computer system, within which instructions 1308 (e.g., software, a program, an application, an applet, an app, or other executable code) for causing the machine 1300 to perform any one or more of the methodologies discussed herein may be executed. For example, the instructions 1308 may cause the machine 1300 to execute instructions 216 of FIG. 2, logic flow 300 of FIG. 3, logic flow 500 of FIG. 5, logic flow 700, logic flow 800 of FIG. 8, and/or logic flow 1000 of FIG. 10, or the like. More generally, the instructions 1308 may cause the machine 1300 to route a path of a vessel on an extravascular image based on at least two points indicated on the image.

The instructions 1308 transform the general, non-programmed machine 1300 into a particular machine 1300 programmed to carry out the described and illustrated functions in a specific manner. In alternative embodiments, the machine 1300 operates as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1308, sequentially or otherwise, that specify actions to be taken by the machine 1300. Further, while only a single machine 1300 is illustrated, the term “machine” shall also be taken to include a collection of machines 200 that individually or jointly execute the instructions 1308 to perform any one or more of the methodologies discussed herein.

The machine 1300 may include processors 1302, memory 1304, and I/O components 1342, which may be configured to communicate with each other such as via a bus 1344. In an example embodiment, the processors 1302 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1306 and a processor 1310 that may execute the instructions 1308. The term “processor” is intended to include multi-core processors that may comprise two or more independent processors (sometimes referred to as “cores”) that may execute instructions contemporaneously. Although FIG. 13 shows multiple processors 1302, the machine 1300 may include a single processor with a single core, a single processor with multiple cores (e.g., a multi-core processor), multiple processors with a single core, multiple processors with multiples cores, or any combination thereof.

The memory 1304 may include a main memory 1312, a static memory 1314, and a storage unit 1316, both accessible to the processors 1302 such as via the bus 1344. The main memory 1304, the static memory 1314, and storage unit 1316 store the instructions 1308 embodying any one or more of the methodologies or functions described herein. The instructions 1308 may also reside, completely or partially, within the main memory 1312, within the static memory 1314, within machine-readable medium 1318 within the storage unit 1316, within at least one of the processors 1302 (e.g., within the processor's cache memory), or any suitable combination thereof, during execution thereof by the machine 1300.

The I/O components 1342 may include a wide variety of components to receive input, provide output, produce output, transmit information, exchange information, capture measurements, and so on. The specific I/O components 1342 that are included in a particular machine will depend on the type of machine. For example, portable machines such as mobile phones will likely include a touch input device or other such input mechanisms, while a headless server machine will likely not include such a touch input device. It will be appreciated that the I/O components 1342 may include many other components that are not shown in FIG. 13. The I/O components 1342 are grouped according to functionality merely for simplifying the following discussion and the grouping is in no way limiting. In various example embodiments, the I/O components 1342 may include output components 1328 and input components 1330. The output components 1328 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1330 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1342 may include biometric components 1332, motion components 1334, environmental components 1336, or position components 1338, among a wide array of other components. For example, the biometric components 1332 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1334 may include acceleration sensor components (e.g., accelerometer), gravitation sensor components, rotation sensor components (e.g., gyroscope), and so forth. The environmental components 1336 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1338 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1342 may include communication components 1340 operable to couple the machine 1300 to a network 1320 or devices 1322 via a coupling 1324 and a coupling 1326, respectively. For example, the communication components 1340 may include a network interface component or another suitable device to interface with the network 1320. In further examples, the communication components 1340 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1322 may be another machine or any of a wide variety of peripheral devices (e.g., a peripheral device coupled via a USB).

Moreover, the communication components 1340 may detect identifiers or include components operable to detect identifiers. For example, the communication components 1340 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1340, such as location via Internet Protocol (IP) geolocation, location via Wi-Fi® signal triangulation, location via detecting an NFC beacon signal that may indicate a particular location, and so forth.

The various memories (i.e., memory 1304, main memory 1312, static memory 1314, and/or memory of the processors 1302) and/or storage unit 1316 may store one or more sets of instructions and data structures (e.g., software) embodying or utilized by any one or more of the methodologies or functions described herein. These instructions (e.g., the instructions 1308), when executed by processors 1302, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1320 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1320 or a portion of the network 1320 may include a wireless or cellular network, and the coupling 1324 may be a Code Division Multiple Access (CDMA) connection, a Global System for Mobile communications (GSM) connection, or another type of cellular or wireless coupling. In this example, the coupling 1324 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1308 may be transmitted or received over the network 1320 using a transmission medium via a network interface device (e.g., a network interface component included in the communication components 1340) and utilizing any one of several well-known transfer protocols (e.g., hypertext transfer protocol (HTTP)). Similarly, the instructions 1308 may be transmitted or received using a transmission medium via the coupling 1326 (e.g., a peer-to-peer coupling) to the devices 1322. The terms “transmission medium” and “signal medium” mean the same thing and may be used interchangeably in this disclosure. The terms “transmission medium” and “signal medium” shall be taken to include any intangible medium that can store, encoding, or carrying the instructions 1308 for execution by the machine 1300, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

Terms used herein should be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to one or multiple ones. Additionally, the words “herein,” “above,” “below” and words of similar import, when used in this application, refer to this application as a whole and not to any portions of this application. When the claims use the word “or” in reference to a list of two or more items, that word covers all the following interpretations of the word: any of the items in the list, all the items in the list and any combination of the items in the list, unless expressly limited to one or the other. Any terms not expressly defined herein have their conventional meaning as commonly understood by those having skill in the relevant art(s).

By using genuine models of anatomy more accurate surgical plans may be developed than through statistical modeling.

What is claimed is:

1. A computer-implemented method, comprising:
receiving, at processing circuitry, an extravascular image from an extravascular imaging device, the extravascular image comprising indications of a vessel;
generating, by the processing circuitry, an image speed map based on the extravascular image;
receiving, by the processing circuitry, an indication of a first point on the extravascular image, the first point corresponding to a portion of the vessel;
identifying, by the processing circuitry, a shortest distance from each of a plurality of pixels on the image to the first point based on the image speed map;
receiving, by the processing circuitry, an indication of a second point on the extravascular image, the second point correspond to another portion of the vessel; and
determining, by the processing circuitry, a path of the vessel based on the second point and the shortest distance from each of the plurality of pixels to the first point.

2. The computer-implemented method of claim 1, comprising smoothing the path.

3. The computer-implemented method of claim 2, wherein the path comprises a midpoint and smoothing the path comprising:
adding an intermediate point along the path on either side of the midpoint;
identifying a shortest path from each of the intermediate midpoints to respective ones of the first point and the second point;
selecting a line or curve segment from a plurality of line or curve segments connecting the intermediate points based in part on the shortest path from each of the intermediate midpoints to respective ones of the first point and the second point; and
forming a path from the shortest path the selected line or curve segment and the shortest path from each of the intermediate midpoints to respective ones of the first point and the second point.

4. The computer-implemented method of claim 1, generating, by the processing circuitry, the image speed map comprising:
de-speckling the extravascular image to generate a de-speckled extravascular image;
normalizing the brightness and/or contrast of the de-speckled extravascular image to generate a normalized extravascular image; and
darkening a centerline of the vessel based in part on the de-speckled extravascular image to generate the image speed map.

5. The computer-implemented method of claim 4, generating, by the processing circuitry, the image speed map further comprising:
identifying ambient light in the de-speckled extravascular image; and
removing the ambient light from the de-speckled extravascular image to form a light adjusted extravascular image, wherein the normalized extravascular image is generate based on the light adjusted extravascular image.

6. The computer-implemented method of claim 5, comprising identifying ambient light in the de-speckled image based on a blurring filter having a median diameter between 30 and 120 pixels.

7. The computer-implemented method of claim 4, comprising applying a Gaussian kernel to the extravascular image to de-speckle the extravascular image.

8. The computer-implemented method of claim 7, wherein the Gaussian kernel is a 3 pixel by 3 pixel diameter Gaussian kernel.

9. The computer-implemented method of claim 4, comprising iteratively applying a mask to portions of the normalized image to progressively darken pixels corresponding to portions of the vessel represented on the normalized image based on a distance of the pixel from the vessel border.

10. The computer-implemented method of claim 4, comprising applying a gradient transformation to the centerline darkened image to generate the vessel speed map.

11. The computer-implemented method of claim 10, wherein the gradient transformation is a Sigmoid transformation or a linear transformation.

12. The computer-implemented method of claim 1, comprising:
identifying, by the processing circuitry, a shortest distance from each of a plurality of pixels on the image to the second point based on the image speed map;
receiving an indication to move a location of the first point;
identifying an updated path of the vessel based on the moved first point and the shortest distance from each of the plurality of pixels to the second point.

13. The computer-implemented method of claim 1, comprising:
identifying, by the processing circuitry, a shortest distance from each of a plurality of pixels on the image to the second point based on the image speed map;
receiving an indication of a midpoint on the extravascular image; and
identifying an updated path of the vessel based on the midpoint and the shortest distance from each of the plurality of pixels to the first point and the midpoint and the shortest distance from each of the plurality of pixels to the second point.

14. A computing device for an extravascular image processing system, the computing device comprising:
a processor; and
a memory device coupled to the processor, the memory device comprising instructions that when executed by the processor cause the computing device to:
receive an extravascular image from an extravascular imaging device, the extravascular image comprising indications of a vessel;
generate, by the processing circuitry, an image speed map based on the extravascular image;
receive, by the processing circuitry, an indication of a first point on the extravascular image, the first point corresponding to a portion of the vessel;
identify, by the processing circuitry, a shortest distance from each of a plurality of pixels on the image to the first point based on the image speed map;
receive, by the processing circuitry, an indication of a second point on the extravascular image, the second point correspond to another portion of the vessel; and
determine, by the processing circuitry, a path of the vessel based on the second point and the shortest distance from each of the plurality of pixels to the first point.

15. The computing device of claim 14, wherein the path comprises a midpoint and wherein the instructions, which when executed by the processor, further cause the computing device to:
add an intermediate point along the path on either side of the midpoint;
identify a shortest path from each of the intermediate midpoints to respective ones of the first point and the second point;
select a line or curve segment from a plurality of line or curve segments connecting the intermediate points based in part on the shortest path from each of the intermediate midpoints to respective ones of the first point and the second point; and
form a path from the shortest path the selected line or curve segment and the shortest path from each of the intermediate midpoints to respective ones of the first point and the second point.

16. The computing device of claim 14, wherein the instructions, which when executed by the processor, further cause the computing device to:
de-speckle the extravascular image to generate a de-speckled extravascular image;
identifying ambient light in the de-speckled extravascular image;
removing the ambient light from the de-speckled extravascular image to form a light adjusted extravascular image;
normalize the brightness and/or contrast of the light adjusted extravascular image;
darken a centerline of the vessel based in part on the de-speckled extravascular image to form a centerline darkened image; and
apply a gradient transformation to the centerline darkened image to generate the image speed map.

17. The computing device of claim 14, wherein the instructions, which when executed by the processor, further cause the computing device to identifying ambient light in the de-speckled image based on a blurring filter having a median diameter between 30 and 120 pixels.

18. A computer-readable medium for an extravascular image processing system, comprising instructions, which when executed by a processor of the extravascular image processing system cause the extravascular image processing system to:
receive an extravascular image from an extravascular imaging device, the extravascular image comprising indications of a vessel;
generate, by the processing circuitry, an image speed map based on the extravascular image;
receive, by the processing circuitry, an indication of a first point on the extravascular image, the first point corresponding to a portion of the vessel;
identify, by the processing circuitry, a shortest distance from each of a plurality of pixels on the image to the first point based on the image speed map;
receive, by the processing circuitry, an indication of a second point on the extravascular image, the second point correspond to another portion of the vessel; and
determine, by the processing circuitry, a path of the vessel based on the second point and the shortest distance from each of the plurality of pixels to the first point.

19. The computer-readable medium of claim 18, further comprising instructions, which when executed by the processor of the extravascular image processing system cause the extravascular image processing system to:
add an intermediate point along the path on either side of the midpoint;
identify a shortest path from each of the intermediate midpoints to respective ones of the first point and the second point;
select a line or curve segment from a plurality of line or curve segments connecting the intermediate points based in part on the shortest path from each of the intermediate midpoints to respective ones of the first point and the second point; and
form a path from the shortest path the selected line or curve segment and the shortest path from each of the intermediate midpoints to respective ones of the first point and the second point.

20. The computer-readable medium of claim 18, further comprising instructions, which when executed by the processor of the extravascular image processing system cause the extravascular image processing system to:
de-speckle the extravascular image to generate a de-speckled extravascular image;
identifying ambient light in the de-speckled extravascular image;
removing the ambient light from the de-speckled extravascular image to form a light adjusted extravascular image;
normalize the brightness and/or contrast of the light adjusted extravascular image;
darken a centerline of the vessel based in part on the de-speckled extravascular image to form a centerline darkened image; and
apply a gradient transformation to the centerline darkened image to generate the image speed map.
